(19) United States
(12) Patent Application Publication
(10) Pub. No.: US 2025/0122854 A1
(43) Pub. Date: Apr. 17, 2025

(54) Direct Gaseous Reformate Injector

(71) Applicant: Technion Research & Development Foundation Limited, Haifa (IL)

(72) Inventors: Leonid Tartakovsky, Haifa (IL); Asher Netzer Lichinitzer, Maale-Adummim (IL)

(73) Assignee: Technion Research & Development Foundation Limited, Haifa (IL)

(21) Appl. No.: 18/915,442

(22) Filed: Oct. 15, 2024

Related U.S. Application Data
(60) Provisional application No. 63/590,424, filed on Oct. 14, 2023.

(51) Int. Cl. F02M 51/06; F02M 61/10

(52) U.S. Cl. CPC F02M 51/061; F02M 61/10

(57) ABSTRACT

A direct gaseous reformate injector that includes an inlet for receiving a gaseous reformate; a plunger; and an outward-opening valve that comprises a valve body and a needle that is movable, by the plunger, in relation to the valve body, between a (a) closed position in which the gaseous reformate is not outputted from the direct gaseous reformate injector, and (b) an open position in which the gaseous reformate is outputted from the direct gaseous reformate injector.

### CROSS REFERENCE

This application claims priority from U.S. provisional patent Ser. No. 63/590,424 filing date Oct. 14, 2023 which is incorporated herein by reference.

### BACKGROUND

Internal combustion Engine (ICE) that uses a conventional fossil fuel is still the main power source of vehicles. Current regulations are limiting air pollution and increases the need for a green, pollution free alternatives.

Many studies focus on hydrogen gas as alternative to the fossil fuel, especially because hydrogen shows wider lean operation limits and higher knock resistance then conventional gasoline. This allows a higher compression ratio inside the cylinders, and higher efficiency. On the other hand, hydrogen suffers from two main disadvantage: storage and safe transportation of the hydrogen and absence of the needed gaseous fueling infrastructure. Moreover, high energy investment is needed for the hydrogen compression because of the low volumetric energy density.

One approach that gives an answer to those disadvantages is the High-Pressure Thermochemical Recuperation (HP-TCR), that uses Liquid Organic Hydrogen Carriers (LOHC) instead of fossil fuels and allows an on-board hydrogen production. In this approach the liquid LOHC fuel is initially pressurized with a negligible energy investment, then the ICE exhaust heat is used for an endothermic reaction that produces hydrogen-rich reformate. An example of such cycle is a methanol-fueled engine with HP-TCR and combustion of a hydrogen-rich reforming mixture, as first developed in the Technion IC Engine Laboratory (TICEL), while the methanol steam reforming (MSR) contains a mole fraction of 75% H₂ and 25% CO₂ injected to the cylinder in a DI method. Many other studies dealt with fuel reforming focus in a port fuel injection (PFI) when the gaseous fuel injected to the intake manifold instead of DI because the result is a well-mixed mixture of the air and the gaseous fuel that allows improved combustion and a reduction of the pollutants. However, this approach leads to a maximal power loss and abnormal combustion in comparison to DI when injecting the fuel after the intake valve closing. In addition, the DI after the intake valve closing reduces dramatically the energy loss occurs when compressing the gaseous fuel together with air at the PFI method. The main limitation of the DI derives mainly from the low volumetric energy density of the reformate. This limitation can be overcome by a large cross-sectional flow area injector together with high injection pressure that delivers large flow rates while the space for a large injector at the engine head is very limited by the valves and spark plug. Additional reasons that a large flow rate injector is needed in the DI configuration is the short available injection window before the in cylinder pressure gets higher than the injection pressure during the compression stroke and the negative impact of a late end of injection (EOI) on the performance and pollutants formation affecting negatively the mixing quality. So far, some hydrogen injectors were investigated, some of them are prototypes and some are conversion of commercial injectors like the STRATA injector, or other injectors. The examined prototypes suffered from a low cross section or even non-stable flow rate.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a direct gaseous reformate injector;

FIG. 2 is an example of a direct gaseous reformate injector and an engine;

FIG. 3 is an example of an MSR injection window;

FIG. 4 is an example of a direct gaseous reformate injector;

FIG. 5 is an example of an experimental setup;

FIG. 6 is an example of a flow chart;

FIG. 7 is an example of valve movements;

FIGS. 8-14 are examples of signals and/or measurements;

FIG. 15 is an example of a direct gaseous reformate injector;

FIGS. 16-21 are examples of signals and/or measurements;

FIGS. 22-29 are examples of at least some parts of direct gaseous reformate injectors; and

FIG. 30 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system

Recent developments in High-Pressure Thermochemical Recuperation technology in the Technion-Israel institute of Technology, were first to allow engines to work on a hydrogen-rich reformate as a stand-alone fuel by its direct injection (DI) to the combustion chamber. This was achieved by using a Magneti Marelli gasoline direct injector, IHP072, modified to enable the gaseous reformate injection. However, this injector, under the used working conditions, suffered from a low flow cross section, non-reliable closure and a non-optimized jet structure, which had a detrimental effect on engine performance. In order to optimize engine performance, i.e. to achieve higher flow rate, shorter open-close timing and higher backward pressure resistance (in the cylinder), an improved injector is needed. In the present work, a novel DI injector was designed producing underexpanded reformate jet.

There is provided an injector that includes an outward-opening valve (POPPET valve) with a relatively high flow cross section. Furthermore, a number of elements have been incorporated in the injector design to allow rapid and convenient calibration of the valve lift, sealing force and the magnetic force. Those in turn, enable optimized injector configuration that is well-suited for different working conditions (such as different in-line pressure or flow rates).

In this work, the direct-gaseous-injector design process is reported, and its operation is optimized and investigated.

The current application refers to a gaseous DI gas injector for the purpose of gathering information and creating a new knowledge-base on injectors design and injection of high-pressure gaseous reformers while so far, to the best of the authors knowledge, such commercial gaseous injectors is not available. The prototype developed is optimized for DI of MSR into a Petter-based laboratory research single-cylinder engine which has been converted into DI operation with SI.

The developed injector prototype has an outward-opening valve with POPPET valve configuration, instead of an inward-opening valve to meet the needed high cross section and flow rate. The injector was designed with an effective diameter of 7.8 [mm] in 0.24 [mm] valve lift and actuated with a solenoid. Furthermore, a number of elements have been incorporated in the injector design to allow rapid and convenient calibration of the valve lift that can reach up to 0.45 [mm], the sealing force and the magnetic force. Those allow optimization of the injector configuration and adaptation to different working conditions (such as different in-line pressure and flow rates).

### Methodology

### Injector Design

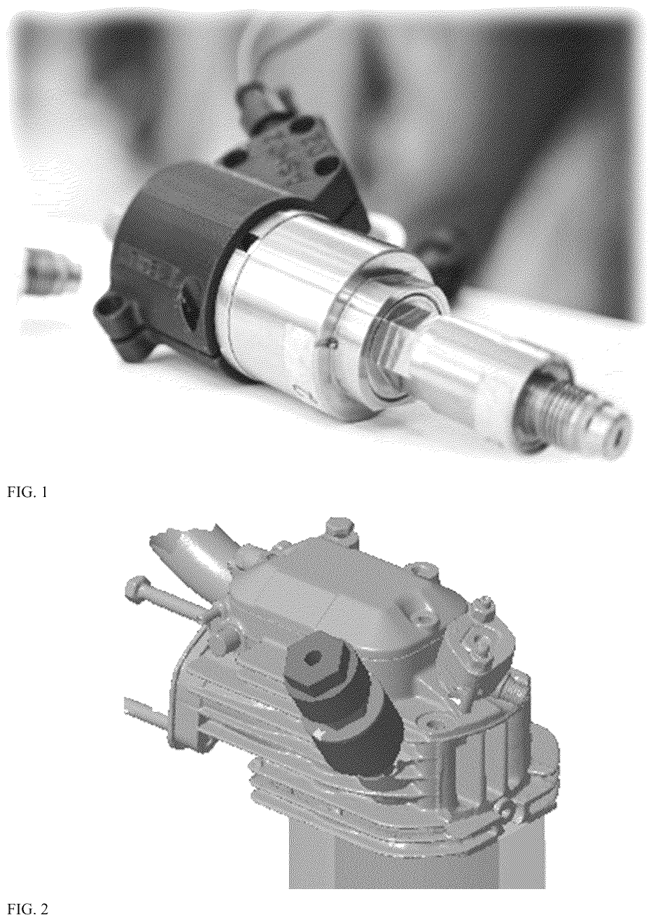

FIG. 1 illustrates an example of a Direct Gaseous Reformate Injector prototype

### Injector Requirements

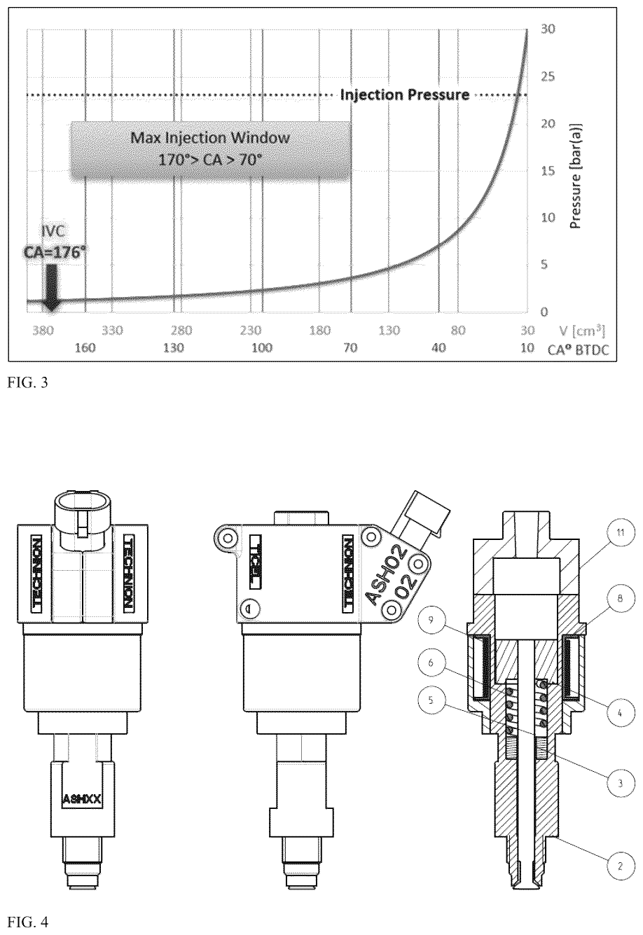

The main requirements from the designed injector as can be seen in FIG. 1 Error! Reference source not found., are integration to a specific motor, injection timing and flow rate. The investigated prototype was developed to enable a convenient integration with a Petter-based laboratory research engine, which has been converted into SI DI operation as shown in FIG. 2 and rotating at 3000 [rpm] for functioning as an electricity generator.

To allow a proper mixing and injection at a relatively low in-cylinder pressure, the maximal injection window was limited as shown in FIG. 3. The following requirements were set: delivering the needed mass flow in a max 5 [msec], which equals to 90 [CA°] at 3000 [rpm]; the MSR injection pressure is 23 [bar (a)] shown by the dashed line in FIG. 3 (In this paper, if not otherwise denoted, all pressures are gauge pressures); and the needed dynamic mass flow is 3.75 [kg/h] over the injection period resulting static mass flow of 30 [kg/h].

Engine geometry: Bore×Stroke—80×73 [mm], Compression ratio of 16 and Displacement of 367 [cm³]

The experiments were conducted with Helium and not MSR (the reasons are described in the experimental setup section). Therefore the criteria for the mass flows after converting the gases using equation
(1) derived by a deviation of equation (2) for the two gases for a chocked flow, 22 [bar] and 20 [C] is: 2.26 [kg/h] Dynamic flow and 18.06 [kg/h] Static flow.

$${\dot{m}}_{1} = {\dot{m}}_{2} \sqrt{\frac{{γ}_{1} {M}_{{w}_{1}}}{{γ}_{2} {M}_{{w}_{2}}}} \frac{{( \frac{1 + {γ}_{1}}{2} )}^{\frac{{γ}_{1} + 1}{2 ( 1 - {γ}_{1} )}}}{{( \frac{1 + {γ}_{2}}{2} )}^{\frac{{γ}_{2} + 1}{2 ( 1 - {γ}_{2} )}}} \qquad ( 1 )$$

### Injector Main Design Principles

An outward-opening POPPET valve was selected, instead of an inward-opening valve. The main reasons are:

The injection pressure, 22 [bar], is much lower than the in-cylinder pressure that can reach above 100 [bar], which can open the valve in an inward-opening valve configuration with a high cross section.

The cylinder pressure naturally seals the valve in an outward configuration which promotes safety and accurate use.

A higher cross area can be reached that will enable higher flow rates which is necessary for gaseous fuels, especially in hydrogen-rich gases that have a relatively low density.

A solenoid actuator was chosen because it is suitable for large valve lift, long pulse width, small fuel quantity delivery and minor complexity of thermal compensation caused by gas temperature or coil heating by controlling the pulse or calibrating the valve lift.

The electro-mechanic design based on an Elementary Approximate solution of the equivalent magnetic circuit shown in equation
(3), and using approximate magnetic curves of the employed materials as developed by Shaanan (S. Shaanan, “Design of a high-speed on-off electropneumatic valve for a control system,” Technion-Israel institute of Technology, Haifa, 1969) was applied. The magnetism of the used materials was taken from the Shannan and wasn't measured in this work. For calibration of the solution, the results obtained with the Strata injector were used and a magnetic analysis was made in FEMM program in addition to a geometric optimization.

$${t}_{on} = {t}_{on , stat} + {t}_{on . dyn} = \frac{{N}^{2}}{{RR}_{1}} ln \frac{1}{1 - \frac{{∅}_{1} {R}_{1}}{NI}} + {( \frac{6 m Δ X}{\frac{IR {∅}_{1}}{{μ}_{0} {A}_{d} N} ( 1 - \frac{{∅}_{1} {R}_{1}}{NI} )} )}^{\frac{1}{3}} \\ {t}_{off} = {t}_{off , stat} + {t}_{off . dyn} = \frac{{N}^{2}}{{RR}_{2}} ln \frac{KNI}{{∅}_{2} {R}_{2}} + {( \frac{6 m Δ X}{\frac{{RR}_{2} {∅}_{2}^{2}}{{μ}_{0} {A}_{d} {N}^{2}}} )}^{\frac{1}{3}} \\ K = \frac{{B}_{s} {A}_{j , min} {R}_{2}}{NI}$$

when closing from circuit's magnetic saturation otherwise K=1 (2)

Mass flow was calculated according to a chocked flow using the General mass flow rate in equation
(3). The C_{D} taken for the preliminary design was 0.55 based on the Strata results which gives 0.24 [mm] needed valve lift, while the inner nominally smallest cross section was approximately twice the flow cross section at the poppet for reducing the pneumatic losses as much as the mechanic design allows.

$$\dot{m} = {C}_{D} {AP}_{0} \sqrt{\frac{γ {M}_{w}}{{RT}_{0}}} {M ( 1 + \frac{γ - 1}{2} {M}^{2} )}^{\frac{γ + 1}{2 ( 1 - γ )}} \qquad ( 3 )$$

The materials were chosen according to the following considerations: Magnetism, Structural strength, Corrosion-mainly hydrogen embrittlement, Sealing-mainly under the hydrogen inner granular material penetration capability, wear, anti-seized metals couples and corrosion.

### Injector Main Features

The injector main features, as can be seen in FIG. 4, are the outward-opening configuration that gives an underexpanded jet which allows high flow rates and few mechanical and electro-mechanical degrees of freedom that enable adjustment and calibration for a wide performance spectrum, such as:

Valve lift change up to 0.45 [mm]. Above this valve lift the nozzle no longer has the smallest flow cross section.

### Spring Force Calibration.

Simple coil assembly replacement which gives the option to change the coil's number or gauge.

Integration to an engine head using a standard M14 spark plug thread.

A relatively long needle that allows convenient integration to the engine head under the valves and spark plug constrains.

Non-welding design that promotes high-pressure sealing.

No over-mold design for easy maintenance.

FIG. 4 illustrates the injector as including valve body 2, spring calibration force busing 3, plunger 4, poppet/needle 5, plunger's spring 6, coils housing 8, coil 9 and gas inlet adapter 11.

### Experimental Setup

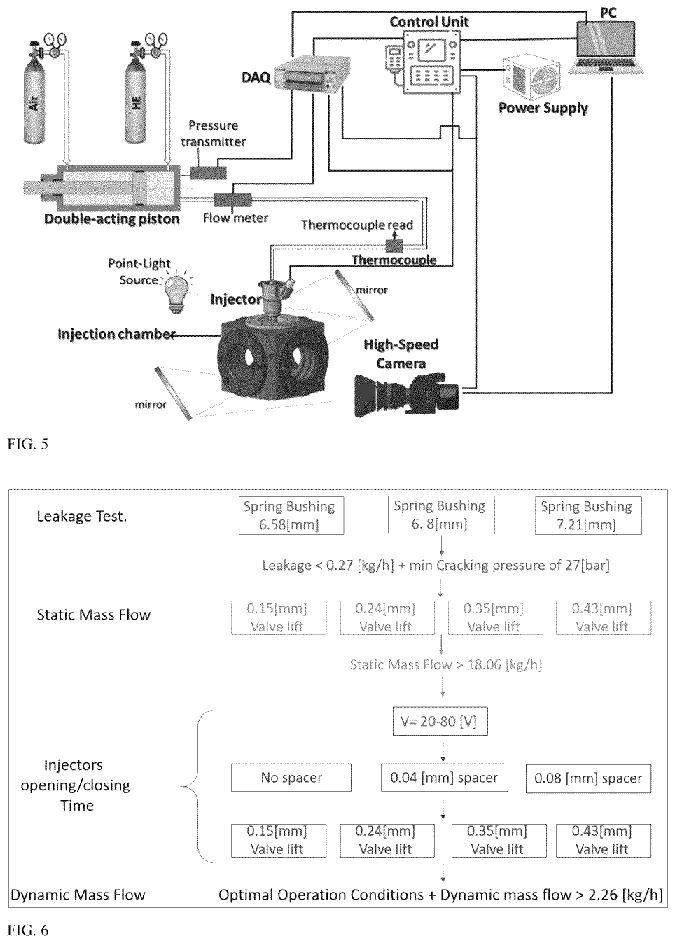

The experimental setup as shown in FIG. 5 is based on a self-designed Injector, which injects gas to a chamber with optical circular windows. The chamber is not sealed and allows injection to an atmospheric-condition environment without external interruptions to the flow. The injectors' poppet movement was sampled with a high-speed camera, using a Shadowgraph technique, based on a Z-type configuration of two parabolic mirror's with 920 [mm] focal length, a point light source of white LED-440 [mW], and a high speed camera-monochrome Phantom V7.3. The camera was equipped with a 200 [mm] Nikon zoom lens: 80-200 [mm] AF NIKKOR 1:2.8 D, located at a distance of 280 [mm] between the frontal lens and the parabolic mirror. Camera frame rate was 10000 [fps]/10 [KHz] and for synchronization of the injectors actuation and camera timeline, camera trigger also was sampled.

The injected gas through all the experiments described in this paper was 99.995% pure Helium which was much safer and simpler to use compared to MSR for the following reasons:
1. It is an inert gas.
2. The low density of the Helium brings to a lower mass flow and as a result to a smaller pressure drop over the mass flow meter (The maximal pressure loss of the Coriolis Bronkhorst M-55-AAD-22-0-S that was used and calibrated to a full scale of 0-30 [kg/h] at 15 [kg\h] flow and 22 [bar] was 0.1 [bar]). Previous work has shown that the penetration of the jet is similar in case of hydrogen and helium (Petersen B. R., “Transient high-pressure hydrogen jet measurements Ph.D. thesis.,” University of Wisconsin, Wisconsin, 2006).
3. The small size of the Helium molecules is close to that of hydrogen and is worsening the leakage test conditions.

To deliver Helium to the injector at a constant injection pressure, especially under the relatively high mass flows, a double-acting piston was used (see FIG. 5). One side of the piston was filled with Helium via a manual regulator connected to a Helium cylinder, and the other side was filled with compressed Air also via a regulator to an Air cylinder. Even though using two gas sources, as can be seen in FIG. 10, the initial pressure drops immediately after the injector opens for almost 5 [bar] and then stabilizes. The reason of the pressure drop is the differentiation between the regulated static and dynamic flow through the cylinder regulators. For this reason, the pressure and mass flow readings were taken close to the injector closing and flow stabilization. After examining various setup configurations, the mass flow meter was located between the Helium tank and the injector, and not before the helium tank like in Schumacher, M. and Wensing, M., “Investigation on an Injector for a Low Pressure Hydrogen Direct Injection,” SAE Technical Paper 2014-01-2699, 2014, for reaching a quicker response of the flow rate reading, in addition to using the double-acting piston as the gas accumulator. The pressure of the helium inside the double acting piston was measured with a Wika S-10-A-BBO-NB-ZKM4ZAZ-ZZZ pressure transmitter and represents the stagnation pressure point for the injector's nozzle. The gas temperature was measured with a K-type Thermocouple before the injector with an analog reader. The injector actuation timing was controlled by an in-house design control unit that has an Arduino board which switches 3 different value resistors and the camera trigger output according to a dedicated Arduino code written for each experimental configuration while the power source comes from an external and adjustable Power Supply (PS)-TTI CPX400D. In experiments where a higher voltage than 60 [V] was needed, an analog power supply was connected in series to the circuit. All the data, except the temperature (that remained stable at room temperature throughout the experiments), was sampled and synchronized by a NI 6212 data acquisition-DAQ in 20 [KHz] system and a dedicated Lab VIEW code for managing the DAQ.

### Experimental Procedure

The injector's performance experiments were divided into 4 sets to utilize and to analyze the injector's performance, such that each test contained fixed parameters. The goal of the first set of experiments was to measure leakage under different spring forces in order to determine the minimum spring force that can withstand the defined max allowed leakage.

The second test was a static mass flow rate measurement under different valve lift values, in order to examine and to find the minimal valve lift that withstands the required static mass flow. The Third test was a measurement of the injector's timing response under different actuation voltage, plunger spacer thickness and different valve lifts in order to determine the optimal actuation and inner configuration. In the last test, Dynamic mass flow measurement was conducted under different actuation timing in order to analyze the performance and to validate that the chosen configuration meets the design requirements. The flow chart in FIG. 6 describes the above process.

### Data Processing

Each measurement was taken only after reaching a steady state, e.g. the dynamic mass flow measurements were taken after approx. 1200 actuation cycles.

The dynamic response of the injector was measured by the fast camera located close to the parabolic mirror and by using a shadowgraph technique focusing the poppet and allowing easily to capture the end movement moments as shown in FIG. 7—illustrating poppet movement measurement using Shadowgraph technique

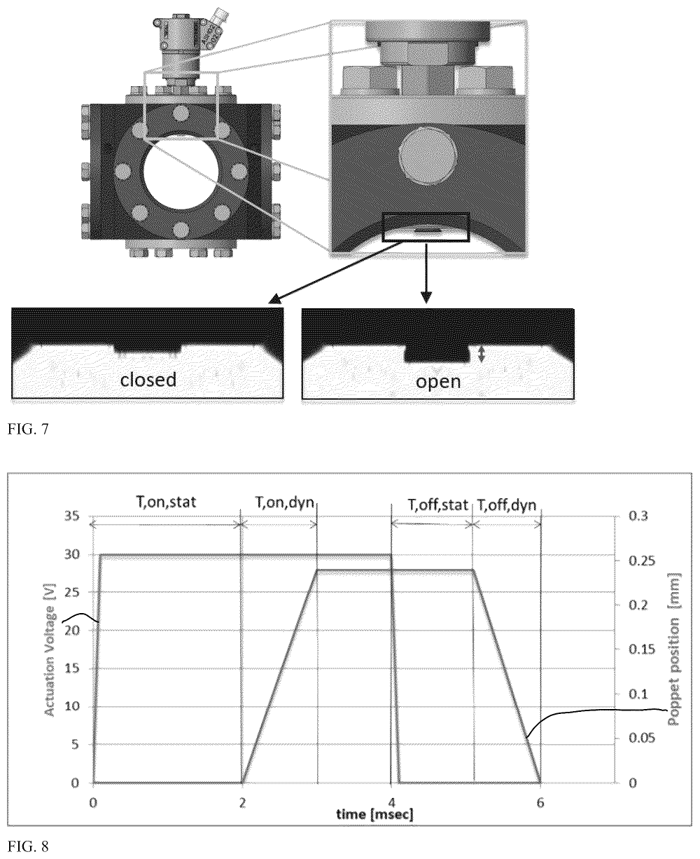

The opening and closing time that was measured by the high-speed camera were divided, as can be seen schematically in FIG. 8 and associated according to equation (2), to 4 stages:
1. t_{on.stat}—the time from actuation current, which synchronized to the camera trigger and measured in the DAQ, till the first frame where mechanical movement towards opening of the poppet is captured. It represents the time that is required for the magnetic force to overcome the force applied by the spring.
2. t_{on.dyn}—the time from t_{on,stat} to the last movement frame, without the bouncing (which was found to be negligible).
3. t_{off,stat}—the time from actuation current drop (a time that found to be very short due to a low near holding current), to the first frame on which a mechanical movement towards closing of the poppet was observed.
4. t_{off,dyn}—represents the mechanical movement from t_{off,stat} to the last movement frame in which the first hit of the poppet at the valve seat (bouncing time until the resting of the poppet was not considered).

FIG. 8 is a schematic timing stages under actuation and poppet position.

### Results and Discussion

### Leakage Test

The goal of the test was to find the optimal spring force by means of injector timing response and sealing performance. Minimal force will lead to a shorter total opening time of the injector, but it is required to withstand the maximum allowed leakage. On the other hand, the higher the spring force, the shorter will be the total closing time (providing that the required performance is far from the natural frequency of the system).

The leakage measurement was conducted with three different bushing lengths. The bushing was placed between the spring and the valve body, as can be seen in FIG. 4 FIG. 4 illustrates. Each measurement taken after 100 actuation cycles in order to allow the parts to reach their balanced position at external atmospheric conditions, while the criteria was chosen to be 1.5% of the Static required mass flow (18.06 [kg/h] of Helium) and 5 [bar] difference between the cracking pressure and the working pressure (22 [bar]). This criterion was chosen according to the assumption that after a few thousand actuations, the leakage will dramatically reduce because the parts will wear each other to an optimal sealing condition as found by Tartakovsky, L. & Amiel, R. & Baibikov, V. & Fleischman, R. & Gutman, M. & Poran, A. & Veinblat, M., “SI Engine with Direct Injection of Methanol Reforming Products-First Experimental Results,” SAE Technical Paper 2015-32-0712, 2015. that measured more than 90% drop in leakage after running their injector for 3 hours. The employed bushing lengths were 6.58; 6.8; 7.21 [mm].

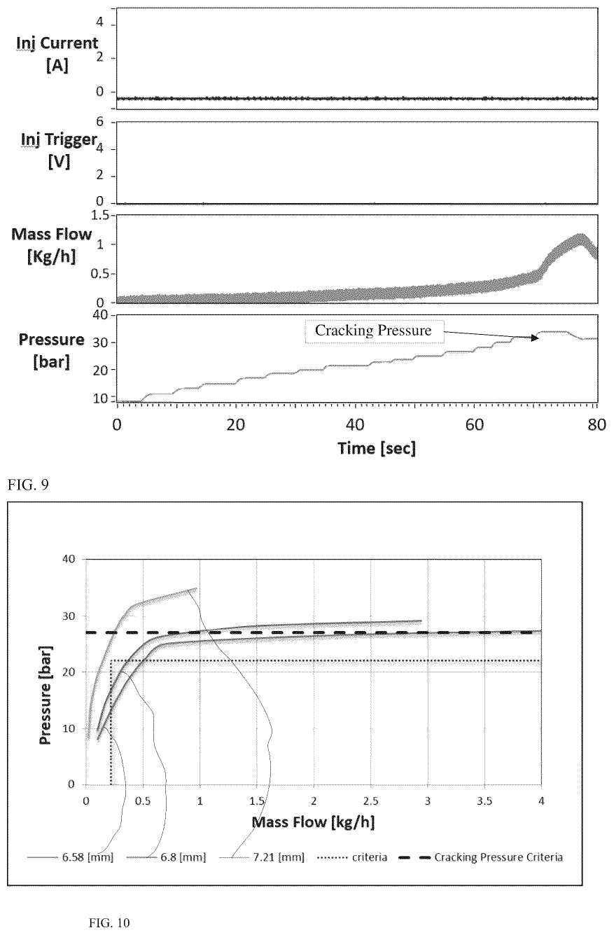

Test conditions required a long period of data recording parallel to pressure change using the Helium Cylinder manual regulator until the flow and pressure stabilized at each step as can be seen in FIG. 9.

The test was stopped when the pressure reached the cracking pressure, above which the force applied by the gas overcomes the spring force and opens the injector (as marked by the arrow in FIG. 9).

As can be seen in FIG. 9, the longest bushing, which gives the highest contact stress between the poppet and the valve seat, withstands the required sealant and gives an approx. 0.15 [kg/h] leakage flow rate with a 32 [bar] of cracking pressure. Therefore, this length was selected for the following experiments. In FIG. 9, the knee phase of each graph represents the gas cracking pressure of the injector as a function of the spring force.

FIG. 10 illustrates Measured Helium leakage mass flow rate over different bushing length and pressures at 20 [C]

Because of the injector configuration (outward poppet), an additional automatic valve between the injector and the gas reservoir should be implemented that will shut off the gas supply to the injector right before the engine shut-off, or in a case of higher injection pressure failure. This requirement is in accordance with areal regulations like Economic Commission for Europe (ECE) that limits the external leakage from hydrogen components to 10 [cm³/h] leakage which is much lower than the 1.5% criteria defined in this study. In addition, it will help to maintain injection pressure for the next engine's ignition and promote safer use, by reducing the chance of leakage from the injector that will result in an external leakage from the intake valve\exhaust valve\piston rings.

### Static Mass Flow

The goal of the following set of experiments is to measure the static mass flow under different valve lifts and to find the minimum valve lift that meets the static mass flow requirement. The main advantages of a short valve lift are:

Shorter opening and closing time, which allows a more efficient use of the injection window.

### More Precise Control.

Less wear. Smaller stresses act at the end of each valve lift because of the smaller kinetic energy needed to be absorbed at the end of each dynamic movement.

The mass flow was measured at 4 different valve lifts: 0.15; 0.24; 0.34; 0.43 [mm]. The 0.43 [mm] valve lift is near the theoretical minimal throat of the inner passages of the injector. Each valve lift was measured at few pressure levels in the range of 8-24 [bar]. A long actuation length of 4504 [msec] was required for reaching a steady state flow under the high mass flow and accuracy of the mass flow measurement as can be seen in FIG. 10 Error! Reference source not found . . . .

It can also be seen in FIG. 10 Error! Reference source not found., that the initial pressure drops immediately after the injector opens. This is due to the differentiation of the regulated static and dynamic flow through the cylinder regulator, as was mentioned earlier.

As can be seen in FIG. 11 Error! Reference source not found., the three higher valve lifts ensure higher mass flow than predefined, e.g. 18.1 [kg/h] at 22 [bar]. By extrapolation, the 0.15 [mm] valve lift gives about 0.9 [kg/h] less mass flow than needed, and 0.24 [mm] valve lift almost meets the point criteria. Therefore, at this stage of the experiments, a 0.24 [mm] valve lift was chosen for the following experiments, even though, the 0.15 [mm] can also be used in case of a dynamic flow measurement, the injection window for the needed mass flow is shorter than the maximum allowed (5 [msec]). It can be seen also that valve lifts longer than 0.24 [mm] give a smaller change of the mass flow compared to the shorter lifts below 0.24 [mm]. This is due to higher pneumatic losses along the inner parts of the injector and the fact that the difference between the injector nozzle flow cross section and the inner passages is reduced with valve lift elongation.

### Injectors Opening and Closing Time

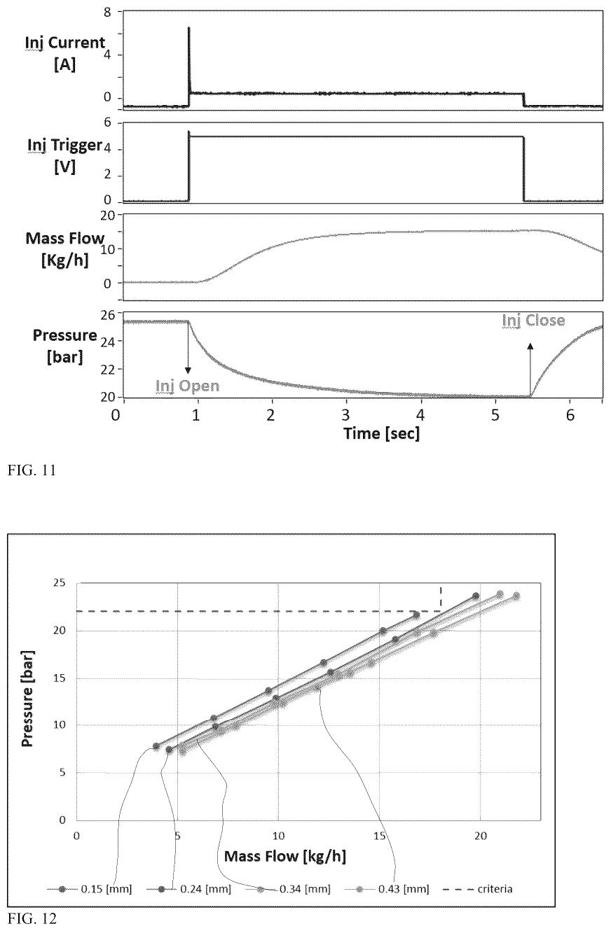

The injector dynamic response examination was divided into three stages: examination of the optimal actuation voltage, optimal spacer thickness between the plunger and the injector's body and a valve lift effects examination. These experiments were conducted under the same actuation profile-10 [msec] for each stage (high current, medium current and low current) as shown in FIG. 12 Error! Reference source not found . . . .

For simplicity, the timing examination tests were conducted with no gas pressure (closed gas supply to the injector) for analyzing the impacts Although tests with gas pressure are expected to give different results, because those examined again after convergence of the free parameters (actuation voltage, valve lift and spacer thickness).

Initially the injector dynamic response was measured for different actuation voltages in the range of 20-80 [V]. The goal was to find the saturation current that gives the fastest opening time without damaging the injector coil and in addition to use the current effectively (from a certain point the magnetic circuit is saturated and higher current does not improve the opening response). The voltage and spacer optimal thickness experiments were conducted under a constant valve lift of 0.24 [mm].

FIG. 13 illustrates voltage actuation vs injectors dynamic time response. 0.24 [mm] valve lift and no spacer

As mentioned earlier, the injector timing response can be divided into four stages, and each stage is affected differently by the voltage change as can be seen in FIG. 13 Error! Reference source not found. . . . Higher actuation voltage results in a shorter static opening time but also in a longer static closing time. This is due to the control unit configuration, which didn't have the option of regulating the 3rd stage resistor value. Therefore, it was decided to continue to the next tests with 60 [V] actuation because:
1. This voltage brings a great improvement in comparison to 80 [V] in terms of the static closing time.
2. Although a longer static closing time received while enlarging the voltage, it can be shortened dramatically by using a different actuation unit adapted to the injectors holding current. In addition, the static closing time can be shortened also by applying a non-magnetic spacer between the plunger and the injector's body as will be presented in the next set of experiments.

Even though the static part of the movement can be compensated by a more sophisticated injector control algorithm (by an early on and shut off without affecting the mass flow), it defines the shortest actuation time and therefore limits the engines maximum speed that the injector can work as the minimum time is the sum of the 3 timing elements-t_{on,dyn}, t_{off,stat}, t_{off,dyn} when using a conventional actuation circuit, as mentioned earlier.

The dynamic opening time-t_{on,dyn}, gets shorter as the magnetic force is proportional to the coil current, but by the fact that small benefit (high gradient in t_{on,stat} graph) was achieved between the 60 [V] actuation and the 80 [V] actuation in this particular case, it can be concluded that the magnetic circuit is not saturated and the limitation comes from an inner digital/electronic power limitation of the PS when the nominal limitation of the used PS model is 420 [W]. If a higher power PS would be used, a shorter opening time could be achieved, and the saturation current could be measured.

The dynamic part of the closing time-t_{off,dyn}, stays constant, due to the fact that the 3rd actuation stage current is pretty low compared to the 1^{st} stage, and as mentioned before, the off time of the current on the coil is very quick, and the mechanical closing is affected almost only by the spring force, mass, inner frictions and pneumatic forces inside the injector.

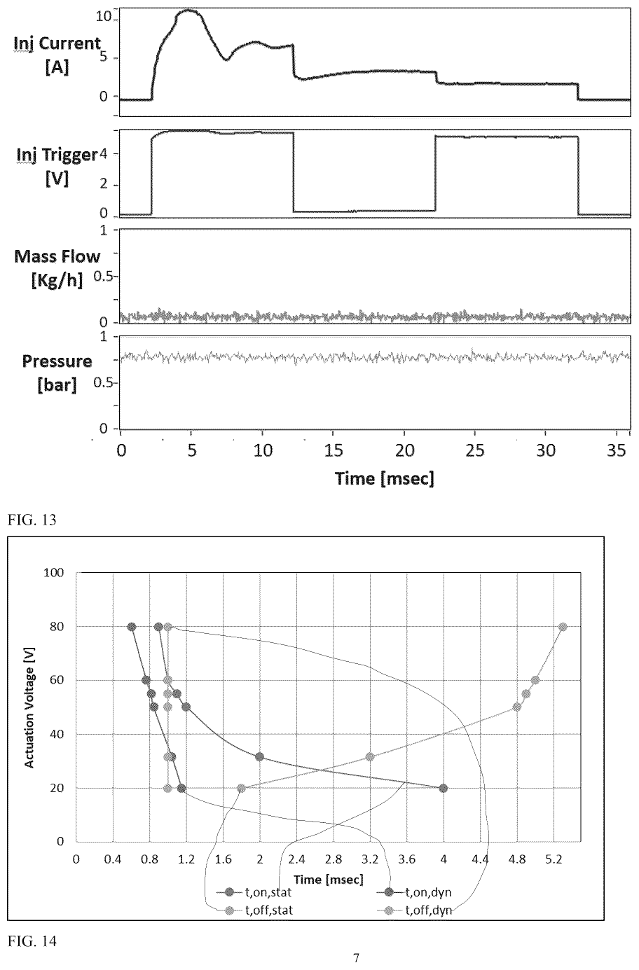

The goal of the next set of experiments was to measure the dynamic response of the injector under nonmagnetic spacing configurations (flat ring with the same external diameter as the plunger) located, as shown in FIG. 14 Error! Reference source not found., between the plunger and the injector body of: 0; 0.04; 0.08 [mm] thickness.

The purpose of the spacer is to reduce the “sticking” effect that occurs when the actuation voltage shuts off and a very high electromagnetic force (EMF) applied on the plunger pulling him to the injector's body against the spring force until the spring force overcomes his force, and leads to a long static closing time-t_{off,stat}, as can be seen in FIG. 13 Error! Reference source not found . . . .

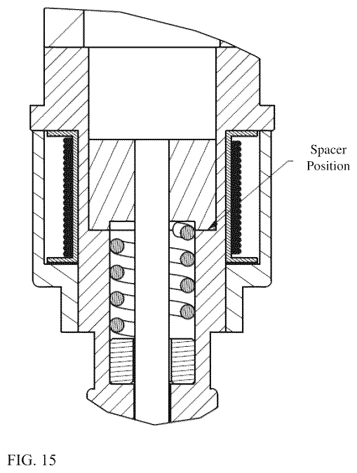

FIG. 15 Error! Reference source not found. shows that the static opening time-t_{on,stat}, is not affected by adding the spacer. This can be explained by a combined effect of the following:

A negligible effect of the air gap increase (the axial space between the plunger and the valve body).

Insufficient measurement resolution. The camera method gives good measurement results of the performance, but a higher frame rate and zoom might be necessary.

Valve lift calibration tolerance (0.014 [mm]), because each spacer assembly required a disassembly of the injector.

In contrast, the static closing time shortened dramatically.

Theoretically in case of an equal importance of the t_{on,dyn} and to t_{off,dyn}, approximately 0.06 [mm] spacer thickness is optimal because it enables an equal dynamic open and closing time. However, because in the cylinder, immediately after the injection during the compression stroke, the pressure rises dramatically and promotes a shorter closing, the decision should be made by considering real conditions.

Based on the above considerations, it was decided that 0.08 [mm] thickness spacer will continue to the valve lift effect examination experiments because of the major static closing time improvement and the negligible effect on the dynamic opening time.

The main goals of the valve lift examination experiments are to measure the dynamic response of the injector under different valve lifts in the range 0.15-0.43 [mm] and to determine the optimal valve lift that withstands the injector's dynamics and enables meeting the mass flow requirements.

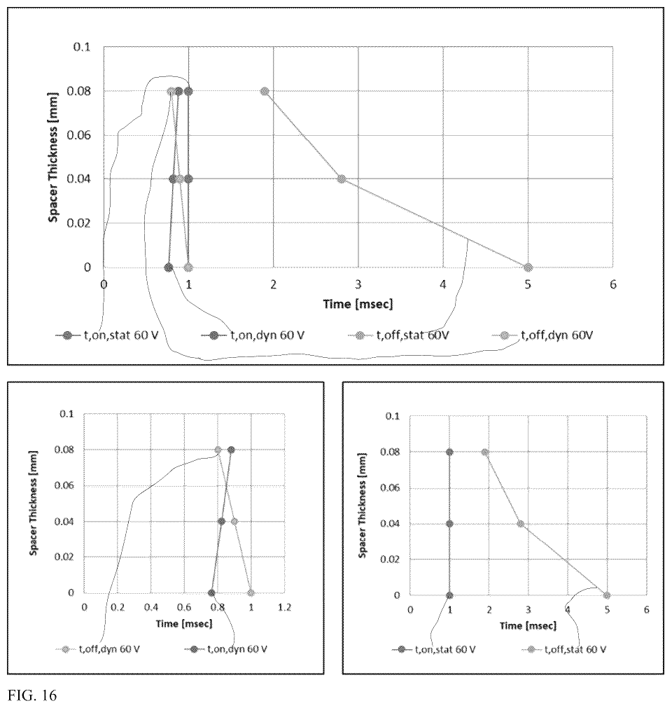

As can be seen in FIG. 16 Error! Reference source not found., the static and dynamic opening time gets longer with the lift rise, because the magnetic force is gradually affected by the air gap between the plunger and the injector's body, (see equation (2)), that changes directly with the valve lift variation, even though the spring force at the static phase, for a specific spring and bushing, gets smaller. As to the dynamic opening and closing time, they both are affected directly from the longer needed valve movement which results in a longer time for longer valve lifts.

Static closing time is not affected by the valve lift, because it depends only on the air gap, which stays the same for different valve lifts.

As a final examination without a gas pressure, this experiment gives a fine picture to determine the needed valve lift, because as mentioned earlier, the minimum injection time, can be roughly determined as the sum of the three timing elements (t_{on,dyn}, t_{off,stat}, t_{off,dyn}), and while 0.15 [mm] valve lift doesn't withstand the static flow requirement with a small gap, the 0.24 [mm] valve lift is very close to the required timing injection performance by assuming that the timing will not change gradually with the gas pressure. The sum of the three timing elements is approximately 3.9 [msec] while the requirement is 5 [msec], therefore, in addition to the mechanical wear and controllability, a 0.15 [mm] valve lift was chosen to be examined first at the dynamic flow test and according to the measurement results of the dynamic flow rate, a decision was made whether also 0.24 [mm] valve lift should be examined.

As to the calculation made in the design phase, a big difference was found between the actual results and the calculated t_{off,stat} (even though the tests conducted without a gas flow), because the model described in equation (2) doesn't take for account the “sticking” effect under small air gaps between the plunger and the valve body or due to the fact that the magnetic calculations were made using material's properties found in the literature when the real magnetic properties can widely vary with slightly different composite or thermal treatments.

### Dynamic Mass Flow

The dynamic mass flow measurement was conducted after all the adjustable parameters were fixed: spring force, actuation voltage, plunger spacer thickness and valve lift. The main goal of the experiments was to measure the dynamic mass flow through the injector under different actuation duty-cycles (D.C) and to see whether the injector withstands the required timing response and mass flow.

The tests were conducted over various actuation profiles that gave different actuation D.Cs in the range of 5-18 [%]\actuation time in the range 2-7 [msec].

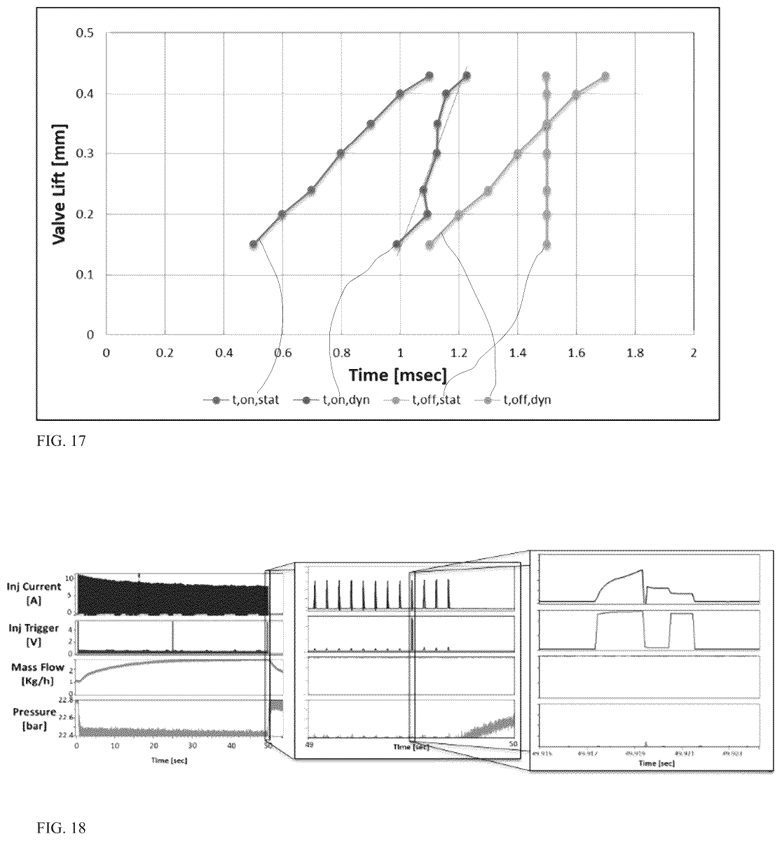

The measurements were carried out for about 1200 actuation cycles for reaching a steady state flow rate as shown in FIG. 17 Error! Reference source not found . . . .

Another reason that could affect the needed cycles number is the time takes for the coil current to stabilize due to thermal changes of the coil. Thermal changes affect the circuit resistance and cause a lower current but because the thermal change stabilizes after approx. 400 cycles and the flow rate after approx. 1100 cycles, the flow rate stabilization determined the measurement length.

Therefore, the results processed are from one of the last cycles as can be seen in FIG. 17 Error! Reference source not found . . . .

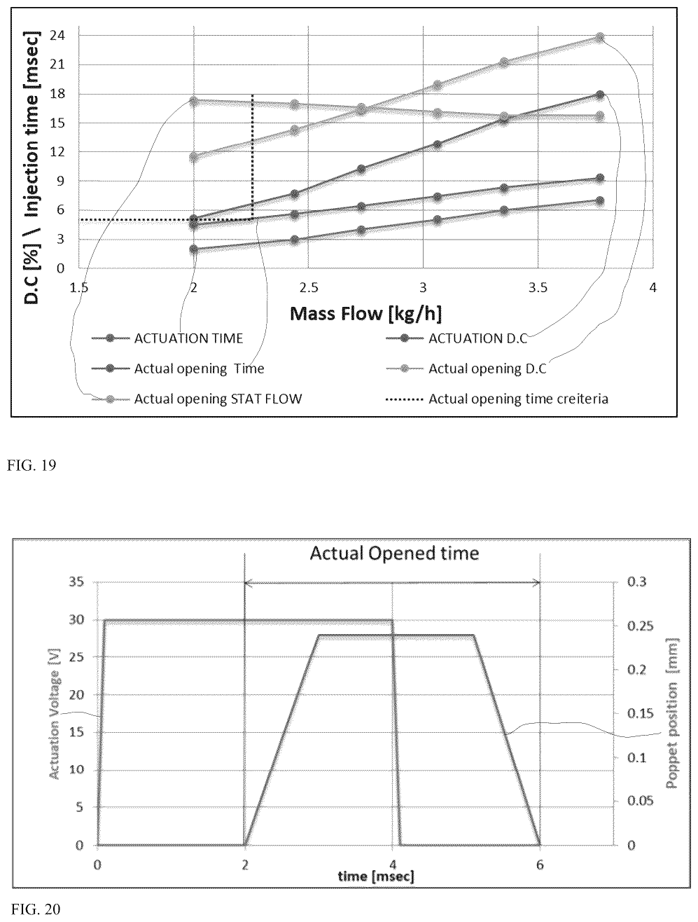

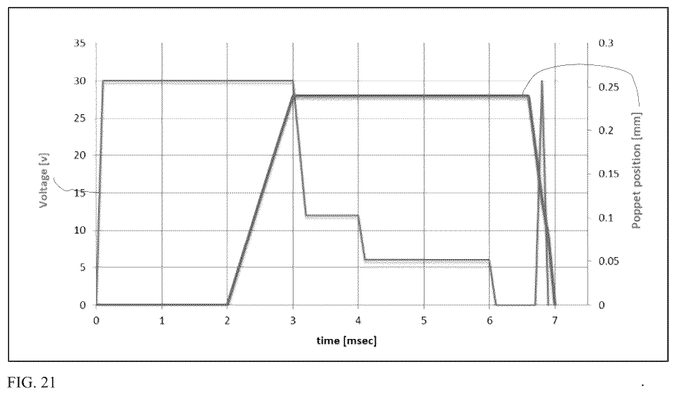

As can be seen in FIG. 18 Error! Reference source not found., for actual time the injector is opened, that includes the dynamic opening and closing time (see FIG. 19 Error! Reference source not found.), the requirement of 5 [msec] injection window, coincide with the required dynamic mass flow for Helium—2.26 [kg/h] and if a longer injection window is possible (depending on the compression ratio or the mixing characteristics inside the cylinder), a much higher dynamic mass flow can be used.

FIG. 19 illustrates an actual opened injector time.

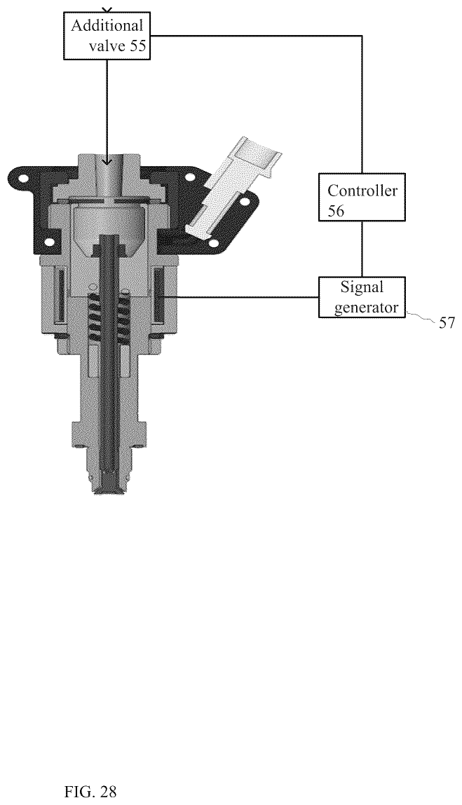

There is some difference in the dynamic mass flow measurement compared to the dynamic mass flow that would be measured while running an engine with the injector due to the facts that the performed mass flow measurement includes also the leakage flow, that, as mentioned earlier, will be smaller after a running-in, and bouncing of the poppet because in real-operation conditions the high backward pressure in the cylinder also reduces the leakage and the poppet closing bouncing. These facts should be taken into consideration when controlling the injector and can be compensated through a longer injection window, elongation of the valve lift or by applying the injector improvements. A way that can reduce the closing bouncing is by applying a damping pulse right before the poppet hits the valve seating as shown in FIG. 20. See also FIG. 28 that illustrates an additional valve 55 that precedes the injector, and well as a controller 56 that controls a signal generator 57 for sending the damping pulse to the coil of the injector.

FIG. 20 illustrates a damping impulse for impact and closure bouncing reduction. As a simple check, the actual opening duty cycle calculated according to the actual opening time (as described earlier), and then converted to a static flow, even though, while the dynamic movement, the flow rate is different than in a wide-open position of the poppet and neglecting the flow rate during the poppet bounces after closing and the leakage while the injector is closed. As can be seen in Error! Reference source not found. 18, the static flow conversion, gives a very close result to the direct static flow measurement for the same 0.15 [mm] valve lift-around 17 [kg/h] (see FIG. 11 Error! Reference source not found.), at the short actuation time, but the result is not steady, and a longer actuation time brings to a lower calculated static flow. This effect occurs due to the changing ratio between the wide opening flow rate, and the flow rate comes from the closing bouncing and the leakage while the injector is closed. In conclusion, as a practical transformation, this method can be used for approximate calculations when a static flow can't be measured, e.g. a limited range of a mass flow meter.

Table 1 shows a comparison of the calculated and mean measured injector performance parameters that were taken under different D.C.

Interesting difference can be seen between the calculated and measured dynamic opening and closing elements, which shows opposite directions. The explanation to that is the fact there is no feature that reduces the instant compression and vacuum pressure effect under the plunger that occurs at each directional movement and has a different profile when opening or closing the injector due to different pneumatic cross section along the inner structure of the injector and adding such a feature, can improve the injector performance gradually.

For realization of the optimization process benefits, a theoretical calculation was made by taking the average measures and adding the expected time using the above results for a working point of 50 [V] actuation, no spacer and 0.2 [mm] valve lift, meaning a small change from the chosen parameters. As can be seen in Table 1, the static timing is gradually affected while the dynamic almost doesn't.

TABLE 1
Injector performance under 0.15[mm] valve lift,
injected gas temperature of 20 [° C.], Actuation
voltage of 60[V] and 0.08 [mm] spacer thickness,
with a comparison to a calculated performance using non-
optimized parameters: 50[V]; without a spacer and 0.2 [mm] valve lift.

| | Injection | | | | |
|---|---|---|---|---|---|
| | Pressure | t_{on.stat} | t_{on.dyn} | t_{off.stat} | t_{off.dyn} |
| | [bar] | [msec] | [msec] | [msec] | [msec] |
| Calculated | 22.36 | 0.3 | 0.9 | 0.4 | 0.7 |
| Results: | | | | | |
| Average | 22.36 | 0.4 | 0.8 | 1.84 | 1 |
| Measure: | | | | | |
| Standard | 0.08 | 0 | 0.034 | 0.075 | 0.09 |
| Deviation: | | | | | |
| Calculated | 22.36 | 0.7 | 0.75 | 4.74 | 1 |
| Non-optimized: | | | | | |

The prototype injector designed for DI of hydrogen\gaseous hydrogen-rich reformate and based on a solenoid activated with an outward injection configuration showed performance compliance, especially for the challenging flow rate and the dynamic requirements that derived from the low volumetric energy density of the injected gas and the short available injection window in DI configuration.

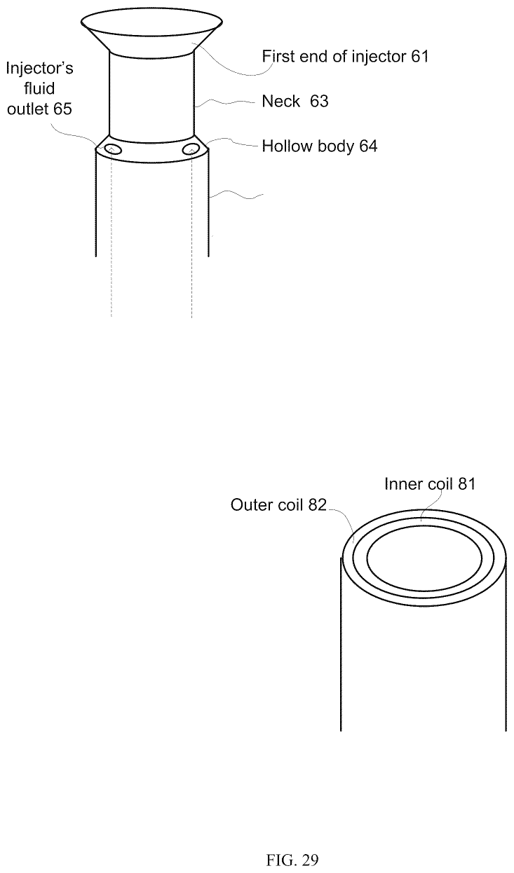

The max leakage achieved, withstands the design requirements when the injector leakage is lower than 0.15 [kg/h] flow rate with a cracking pressure of 32 [bar] under Helium use, when a much lower leakage flow rate is expected after a longer operation time\actuations. In addition, because of the injector configuration (outward poppet), an additional automatic valve between the injector and the gas reservoir should be implemented that will shut off the gas supply to the injector right before the engine shut off or in a case of a higher injection pressure failure to meet areal regulations. See, for example, FIG. 29 that illustrates a controller that controls the additional value (between the injector and the reservoir. In addition, it will help to keep the injection pressure for the next engine cycle and promote safer use, because leakage from the injector leads directly to an external leakage from the intake valve\exhaust valve\piston rings.

Based on the static mass flow measurements, a valve lift smaller than 0.24 [mm] can be used because the lift 0.15 [mm] is close to withstand the dynamic mass flow with a slightly longer actuation which promotes advantages compared to a longer valve lift.

The differences between the dynamic flow measurement test and real-operation conditions should be considered. Indeed, in real operation the backward pressure in the cylinder reduces the leakage, the closing bouncing amplitude and time. Those differences can be compensated by a longer injection time or enlarging the valve lift.

For reaching an optimal opening and closing time, it's necessary to use control unit that supports an adaptation\calibration to the injector min holding current in addition to a higher power PS use (or using smaller power PS boxes with a parallel connection). It was found that the magnetic circuit didn't reach saturation at the experiment configuration so a much better performance can be easily achieved for the developed injector.

The magnetic model used, even though being approximate, showed a close prediction of the injector performance except at the static closing time because the model doesn't consider the “sticking” effect under small air gaps between the plunger and the valve body that should be addressed in future injectors design and compensated by using an optimal nonmagnetic spacer and applying min holding current.

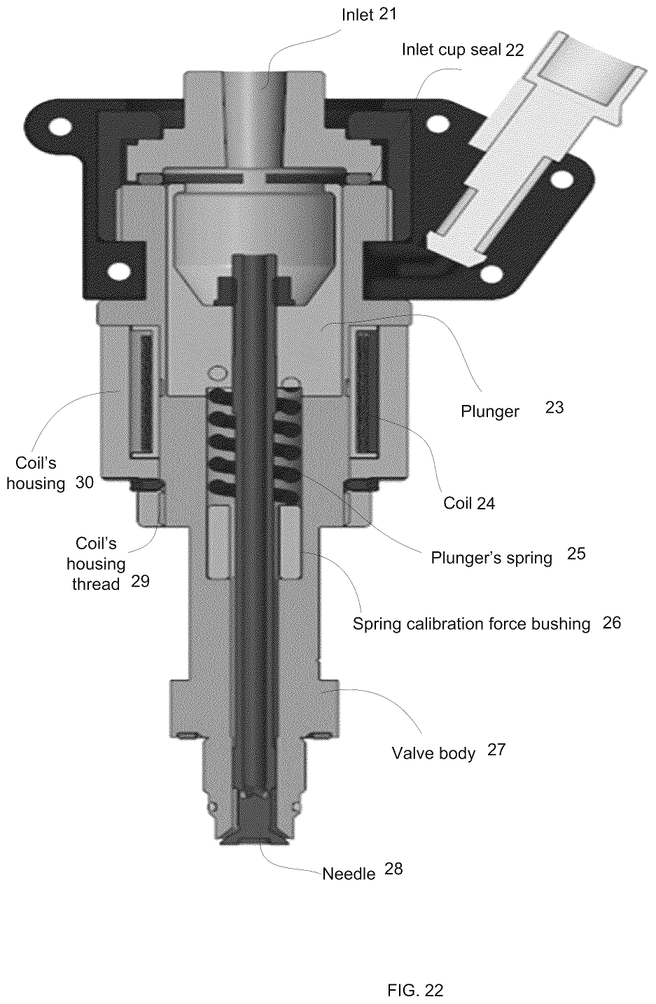

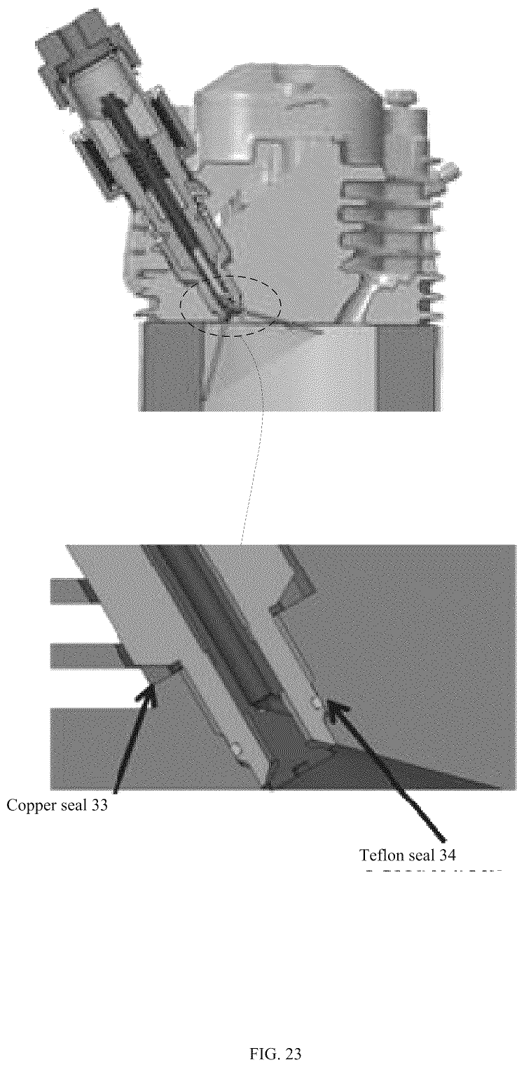

FIG. 22 illustrates an example of the injector as including inlet 21, inlet cup seal 22, plunger 23, coil 24, plunger's spring 25, spring calibration force busing 26, valve body 27, poppet/needle 28, coil's housing 30, and coil's housing thread 29.

FIG. 23 illustrates an example of a Teflon seal 34 and a copper seal 33 positioned on the valve body.

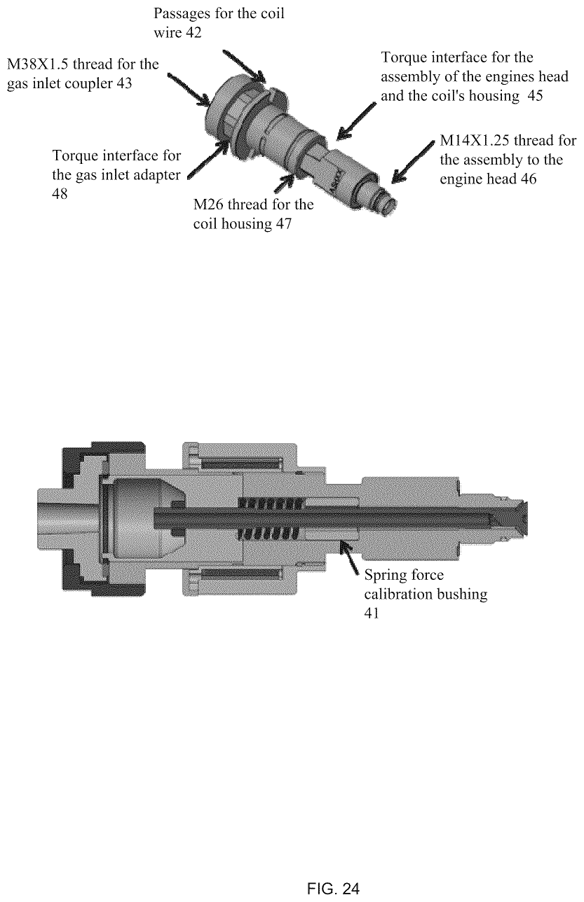

FIG. 24 illustrates elements of the valve body that include passages for the coil wire 42, M38X1.5 thread for the gas inlet coupler 43, a torque interface for the assembly of the engines head and the coil's housing 45, a M14X1.25 thread for the assembly to the engine head 46, M26 thread for the coil housing 47, and Torque interface for the gas inlet adapter 48. FIG. 24 further illustrates spring force calibration bushing 41.

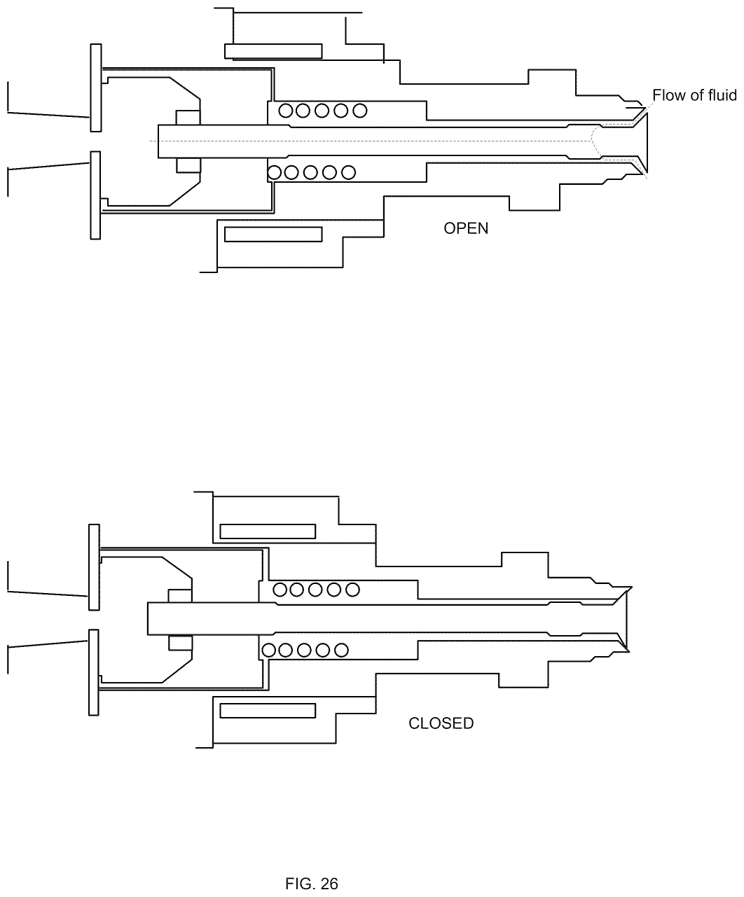

FIG. 26 illustrates the injector when opened and when closed.

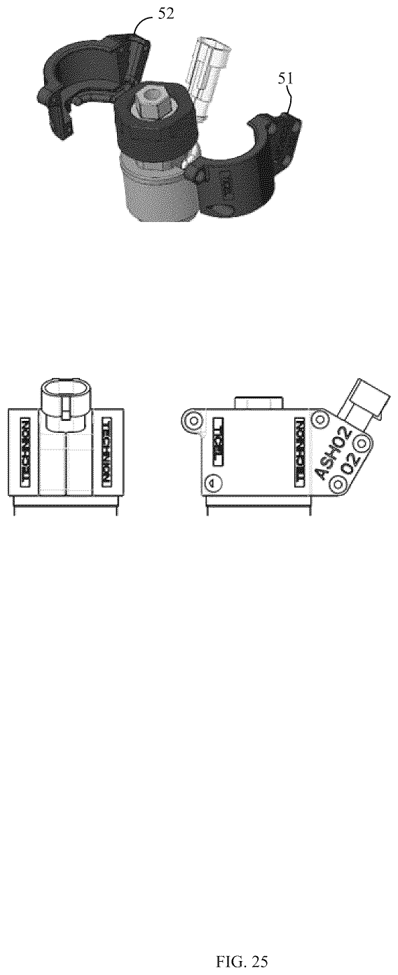

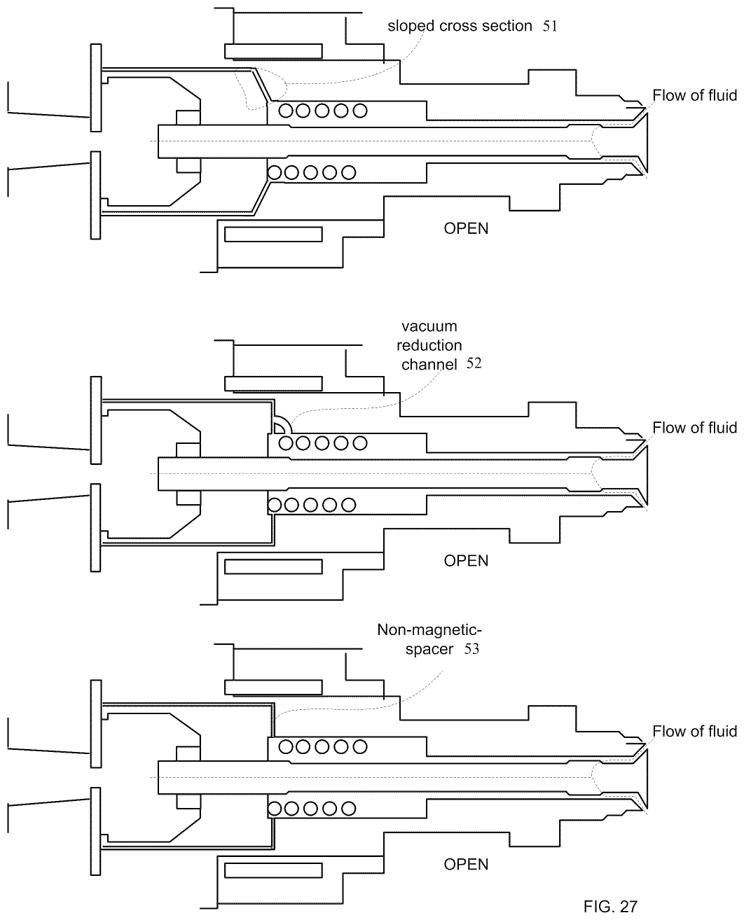

According to one or more embodiments, further improvement of the injector opening and closing timing are provided and include:
1. Implementation of an armature made from two coils (denoted 51 and 52 in FIG. 25) connected in a parallel configuration and turned on the same housing, when each coil has half of the turns calculated. This method may improve the timing gradually and doesn't require any mechanical change of the injector parts. See, for example the inner coil 81 and the outer coil 82 of FIG. 29.
2. Optimization of the plunger geometry to geometry that will produce a different EMF profile i.e. a conical face. See, for example the sloped cross section 51 of FIG. 27.
3 Adding a feature that will reduce the instant compression and vacuum pressure effect under the plunger that occurs at each directional movement and has a different profile when opening or closing the injector due to different pneumatic cross section along the inner structure of the injector. See, for example the vacuum bypass channel (such as vacuum reduction channel 52 of FIG. 27), that fluidly coupled the inner space in which the spring is located with the inner space between the plunger and the valve body.

FIG. 29 also illustrates the truncated conical first end of the injector 61 followed by a neck that is followed by a hollow body 84 that includes fluid outlets 65.

A further work and examination of the chosen materials should be done under the neat hydrogen environment and the hot operational environment that can cause an excessive wear and a show of hydrogen embrittlement phenomenon especially in parts under high tensile stresses like the spring and the needle valve, in addition to durability tests.

The design process described in the article showed an efficient way of examination and validation for finding the optimal injectors operation parameters, which is very important for achieving the best performance while integrating the injector to an engine by meaning of timing, controllability, required flow rate and leakage.

After the injector examination, it was found that the developed injector meets the requirements and can be immediately used in a laboratory engine with DI of a hydrogen-rich reformate. Even though a further work is needed to improve the injector performance, the study results show that high mass flow rates of the reformate are achieved under relatively low injection pressure. The latter promotes a higher conversion rate of the primary fuel, thus enabling larger hydrogen yield. Moreover, the higher injection reformate mass flow rate enables reducing the injection event duration with subsequent reduction in particle formation. Finally, the mentioned above benefits are achieved in a relatively compact injector design as compared to the former designs based on an inward valve opening or modification of existing gasoline DI injectors.

### Abbreviations

EMF Electro-Magnetic Force
MSR Methanol Steam Reforming
t_{on,stat} Static Opening Time
t_{on,dyn} Dynamic Opening Time
t_{off,stat} Static Closing Time
t_{off,dyn} Dynamic Closing Time
D.C Duty Cycle
LOHC Liquefied Organic Hydrogen Carriers
SI Spark Ignited
DI Direct Injection
PFI Port Fuel Injection
HP-High-Pressure Thermochemical Recuperation
TCR
TCR Internal Combustion Engine
ICE Internal Combustion Engine Port Fuel Injection
EOI End of Injection
IVC Intake Valve Closing
CA Cam Angle
BTDC Before Top Dead Center
[bar(a)] Absolute pressure in [bar]
Symbols
   γ Specific Heat Ratio
   M_{w} Gas Molecular Weight
   N Coil's Turns No.
   R Coil's ohm Resistance\
      Universal Gas Constant
   R₁, Circuit's magnetic resistance at closed/opened position
R₂ relatively
   Ø₁, Magnetic flux at beginning of opening/closing movement
Ø₂ of the plunger relatively
   I Circuit's Current
   m Total Moving Mass
   ΔX Plungers Stroke
   μ₀ Magnetic Permeability In Vacuum
   A_{d} Plunger's Cross Section Area
   Bₛ Saturated Magnetic Induction
   A_{j,min} Minimal cross section of the magnetic circuit
   T₀ Stagnation Temp
   P₀ Stagnation Pressure
   A Nozzle flow area
   M Mach Number
   C_{D} Discharge Coefficient

According to an embodiment, there is provided a direct gaseous reformate injector that includes an inlet for receiving a gaseous reformate, a plunger; and an outward-opening valve that comprises a valve body and a needle that is movable, by the plunger, in relation to the valve body, between a (a) closed position in which the gaseous reformate is not outputted from the direct gaseous reformate injector, and (b) an open position in which the gaseous reformate is outputted from the direct gaseous reformate injector.

According to an embodiment, the gaseous reformate injector further includes a coil that is located within a coil housing, wherein the plunger is configured to move the needle under a control of an axial magnetic force generated by the coil.

According to an embodiment, the coil is located outside the valve body.

According to an embodiment, the coil housing includes a coil housing thread that interfaces with a corresponding valve housing thread.

According to an embodiment, the coil housing thread is configured to reduce a magnetic flux.

According to an embodiment, the gaseous reformate injector further includes a spring that is configured to move the plunger to a default position.

According to an embodiment, the gaseous reformate injector further includes a spring force calibration element.

According to an embodiment, the gaseous reformate injector further includes a fluid conduit (such as vacuum reduction channel 52 of FIG. 27) that fluidly couples a first inner space in which a spring is located and a second inner space formed between the plunger and the valve body.

According to an embodiment, the valve body is a single part. According to an embodiment the valve body is not glued and/or not welded to any other part.

According to an embodiment, the gaseous reformate injector further includes a non-magnetic spacer located between the valve body and the plunger. See, for example non-magnetic spacer 53 of FIG. 27.

According to an embodiment, there is provided a device that includes a controller; and a gaseous reformate injector.

According to an embodiment, the controller is configured to control a provision of a control signal to the coil.

According to an embodiment, the control signal is a damping signal.

According to an embodiment, the device further includes an additional valve that is located upstream to the gaseous reformate injector, wherein the controller is configured to control a supply of fluid to the gaseous reformate injector.

According to an embodiment, there is provided a method for direct gaseous reformate injection, the method includes: receiving a gaseous reformate, by an inlet of a direct gaseous reformate injector; outputting the gaseous reformate, by the direct gaseous reformate injector, while a needle of an outward-opening valve is positioned, by a plunger of the outward-opening valve, in an open position; and preventing an output of the gaseous reformate from the direct gaseous reformate injector, while the needle is positioned, by the plunger of the outward-opening valve, in a closed position.

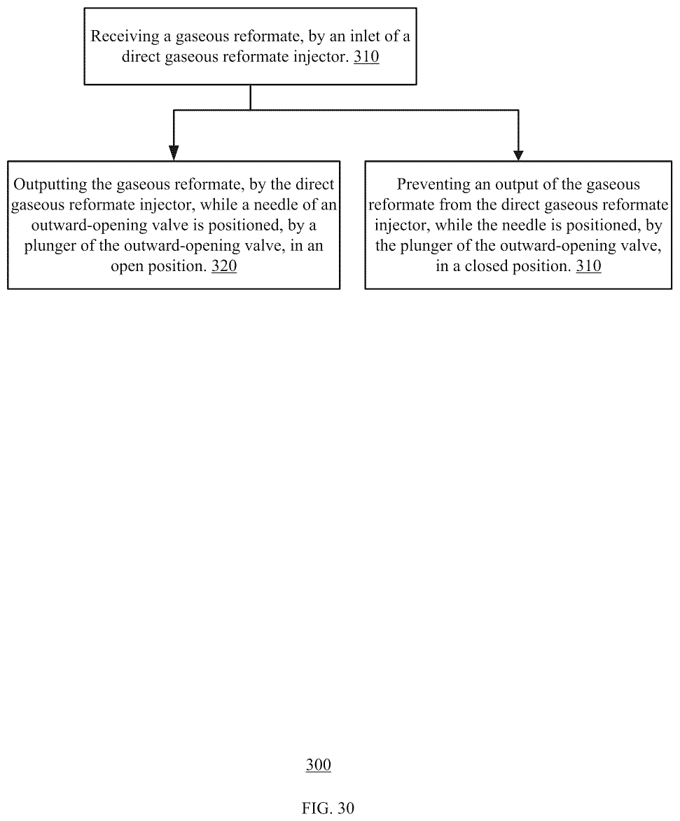

FIG. 30 illustrates an example of method 300, for direct gaseous reformate injection.

According to an embodiment the method includes operating any of the direct gaseous reformate injector illustrated in the specification and/or drawings.

According to an embodiment, method 300 includes step 310 of receiving a gaseous reformate, by an inlet of a direct gaseous reformate injector.

According to an embodiment, step 310 is followed by step 320 of outputting the gaseous reformate, by the direct gaseous reformate injector, while a needle of an outward-opening valve is positioned, by a plunger of the outward-opening valve, in an open position.

According to an embodiment, step 320 is followed by step 330 of preventing an output of the gaseous reformate from the direct gaseous reformate injector, while the needle is positioned, by the plunger of the outward-opening valve, in a closed position.

According to an embodiment, step 320 includes moving, by the plunger, the needle under a control of an axial magnetic force generated by a coil that is located within a coil housing.

According to an embodiment, method 300 includes moving, by a spring, the plunger to a default position.

According to an embodiment, method 300 includes calibrating the spring by a spring force calibration element.

According to an embodiment, method 300 includes fluidly coupling, by a fluid conduit, a first inner space in which a spring is located and a second inner space formed between the plunger and the valve body.

According to an embodiment the method includes operating any combination of a controller of the direct gaseous reformate injector illustrated in the specification and/or drawings.

According to an embodiment, method 300 includes controlling, by a controller, a provision of a control signal to the coil.

According to an embodiment, the control signal is a damping signal.

According to an embodiment the device includes an additional valve (such as additional valve 55 of FIG. 28) that is located upstream to the gaseous reformate injector, and method 300 also includes controller is configured to control a supply of fluid to the gaseous reformate injector.

According to an embodiment, method 300 includes introducing a space between the valve body and the plunger using a non-magnetic spacer located between the valve body and the plunger.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A direct gaseous reformate injector that comprises:
an inlet for receiving a gaseous reformate;
a plunger; and
an outward-opening valve that comprises a valve body and a needle that is movable, by the plunger, in relation to the valve body, between a (a) closed position in which the gaseous reformate is not outputted from the direct gaseous reformate injector, and (b) an open position in which the gaseous reformate is outputted from the direct gaseous reformate injector.

2. The gaseous reformate injector according to claim 1, further comprising a coil that is located within a coil housing, wherein the plunger is configured to move the needle under a control of an axial magnetic force generated by the coil.

3. The gaseous reformate injector according to claim 2, wherein the coil is located outside the valve body.

4. The gaseous reformate injector according to claim 2, wherein the coil housing comprises a coil housing thread that interfaces with a corresponding valve housing thread.

5. The gaseous reformate injector according to claim 4, wherein the coil housing thread is configured to reduce a magnetic flux.

6. The gaseous reformate injector according to claim 1, further comprising a spring that is configured to move the plunger to a default position.

7. The gaseous reformate injector according to claim 6, further comprising a spring force calibration element.

8. The gaseous reformate injector according to claim 6, further comprising a fluid conduit that fluidly couples a first inner space in which a spring is located and a second inner space formed between the plunger and the valve body.

9. The gaseous reformate injector according to claim 1, wherein the valve body is a single part.

10. The gaseous reformate injector according to claim 1, further comprising a non-magnetic spacer located between the valve body and the plunger.

11. A device, comprising:
a controller; and
a gaseous reformate injector that comprises (a) a plunger; and an outward-opening valve that comprises a valve body and a needle that is movable, by the plunger, in relation to the valve body.

12. The device according to claim 11, wherein the gaseous reformate injector further comprises a coil that is located within a coil housing, wherein the plunger is configured to move the needle under a control of an axial magnetic force generated by the coil.

13. The device according to claim 12, wherein the controller is configured to control a provision of a control signal to the coil.

14. The device according to claim 13, wherein the control signal is a damping signal.

15. The device according to claim 11, further comprising an additional valve that is located upstream to the gaseous reformate injector, wherein the controller is configured to control a supply of fluid to the gaseous reformate injector.

16. A method for direct gaseous reformate injection, the method comprises:
receiving a gaseous reformate, by an inlet of a direct gaseous reformate injector;
outputting the gaseous reformate, by the direct gaseous reformate injector, while a needle of an outward-opening valve is positioned, by a plunger of the outward-opening valve, in an open position; and
preventing an output of the gaseous reformate from the direct gaseous reformate injector, while the needle is positioned, by the plunger of the outward-opening valve, in a closed position.

17. The method according to claim 16, further comprising moving, by the plunger, the needle under a control of an axial magnetic force generated by a coil that is located within a coil housing.

18. The method according to claim 16, further comprising moving, by a spring, the plunger to a default position.

19. The method according to claim 18, further comprising calibrating the spring by a spring force calibration element.

20. The method according to claim 18, further comprising fluidly coupling, by a fluid conduit, a first inner space in which a spring is located and a second inner space formed between the plunger and the valve body.

21. The method according to claim 16, wherein the valve body is a single part.

22. The method according to claim 16, further comprising introducing a space between the valve body and the plunger using a non-magnetic spacer located between the valve body and the plunger.
